(19) United States
(12) Patent Application Publication
(10) Pub. No.: US 2002/0089175 A1
(43) Pub. Date: Jul. 11, 2002

(54) Spiral ribbed tubing connector for irrigation stakes and couplings

(76) Inventor: Michael R. Ericksen, Farmington, UT (US)

Correspondence Address: MALLINCKRODT & MALLINCKRODT, 10 EXCHANGE PLACE, SUITE 510, SALT LAKE CITY, UT, 84111, US

(21) Appl. No.: 09/928,844

(22) Filed: Aug. 12, 2001

Related U.S. Application Data
(60) Provisional application No. 60/224,758, filed on Aug. 12, 2000.

(51) Int. Cl. F16L 43/00; F16L 3/00

(52) U.S. Cl. 285/61; 285/179

(57) ABSTRACT

A connector for connecting a length of smooth inside walled, substantially flexible irrigation pipe to an item, such as a sprinkler, another irrigation pipe, or a garden hose, includes a connector body with fittings extending therefrom for connection to both a smooth inside walled, substantially flexible irrigation pipe and to an item to deliver or supply water. In this way an above ground irrigation system having a plurality of sprinklers connected by lengths of irrigation pipes can be constructed and easily repositioned. The fitting for connecting to a smooth inside walled, substantially flexible irrigation pipe includes a tubular fitting body extending from the connector body tapering from a maximum outside diameter adjacent the connector body to a minimum diameter at a remote end away from the connector body, the minimum diameter being less than the normal inside diameter of the pipe to be connected, and a spiral rib extending spirally around the fitting body from a starting position away from the coupling body and extending toward the coupling body, the spiral rib having an edge along its length radially outwardly of the fitting body from which it extends, said edge tapering radially outwardly as it approaches the coupling body and having an outer diameter greater than the inside diameter of the pipe as it approaches the coupling body. A pilot rib may also be provided adjacent the remote end of the fitting body.

### RELATED APPLICATIONS

This application claims the benefit of Provisional Application Ser. No. 60/224,758, filed Aug. 12, 2000, and entitled Spiral Ribbed Tubing Connector For Irrigation Stakes And Couplings.

### BACKGROUND OF THE INVENTION

1. Field

The invention is in the field of pipe connectors, fittings, and couplings, for connecting flexible plastic pipes or hoses together primarily for use in above ground lawn, yard, and other area sprinkler systems.

2. State of the Art

Watering of lawns, yards, and fields has been a continuing challenge in dry areas of the world such as the western part of the United States. Initially such watering was done through flood irrigation were running surface water was carried in ditches and diverted into areas such as fields where water was desired. Where pressurized water is available, hoses, such as garden hoses, are attached to faucets which provide pressurized water to the hoses which direct the water to desired locations where it is sprayed through nozzles to the area to be watered. Such nozzles take many forms such as those held by a user and those which can be stuck into the ground or rest on the ground to be left unattended for periods of watering. Underground watering systems are currently extensively used particularly for watering lawns and yards, where underground pipe is laid with feed pipes extending to the surface and sprinklers secured thereto throughout the yard arranged at locations determined by the range of the sprinklers so that the yard is sufficiently watered. The underground systems are permanent installations used with permanently landscaped yards.

Were temporary systems are desired, the hose solution mentioned above is the most practical since it provides an above ground system that can be move easily to change locations of the sprinklers as desired to water an area needing watering. Stands for connecting various types of sprinklers, such as impact sprinklers, pop-up sprinklers, or various other types of sprinklers generally used with underground watering systems, to garden hoses so that several such sprinklers can be connected to and between several lengths of garden hose and arranged as desired in an area to be watered, are currently available. One or more lengths of hose connects the first stand with a source of water and one or more lengths of hose then extend from one stand to the next stand to interconnect a plurality of such stands to provide a series of stands and sprinklers attached thereto for arrangement in an area to be watered. Sprinkler heads have ranges over which they water and such sprinkler heads should be arranged set distances apart based upon their range. Garden hoses come in predetermined set commercial lengths which generally have no relation to the distances apart certain sprinkler heads should be spaced. Thus, with a length of a plurality of sprinkler stands connected by lengths of commercially available garden hoses, a user has to correctly space the sprinkler heads each time the heads are moved. This can require inconvenient measuring each time the sprinklers are moved, or a user can merely guess as to the correct spacing, and if wrong, not provide satisfactory water coverage for the area being watered. In addition, commercially available garden hoses are relatively expensive.

One type of plastic pipe sometimes used in underground sprinkler systems is a substantially flexible, polyethylene plastic pipe which comes in rolls and is cut into desired lengths for use. Such pipe is circular in cross-section with a smooth interior and exterior surface. Cut lengths of such pipe are coupled together such as by using pipe fittings which press into the ends of the pipe or screw into or onto the ends of the pipe. Hose clamps are generally used in association with the connectors to ensure a tight fit to keep the connectors from separating from the pipe and to prevent leakage. This type of pipe is relatively inexpensive, but not easy to use in above ground systems.

Pipe connectors and fittings used with such pipe typically have a tubular, combined sealing and gripping member through which the irrigation water flows from the pipe to the pipe fitting or vice versa. Such tubular member is inserted into the pipe and at least a portion thereof closely fits within the pipe against the generally smooth interior surface thereof. The tubular member typically has a plurality of longitudinally extending, coaxial, frustoconical ridges or annular barbs, the circumferential edges of which contact the interior surface of the pipe to provide both a sealing function against water leakage and a gripping function to axially retain the tubular member within the pipe against the water pressure or other such mechanical separation force. The sealing function of the frustoconical ridges is enhanced by using ribs which are somewhat blunt at the circumferential edges thereof so as to provide a greater contact area with the interior surface of the pipe. The gripping function of the frustoconical ridges, however, is enhanced by using ribs the circumferential edges of which are sharp so as to greater deform and grip the interior surface of the pipe. Therefore, a compromise must be made such that the circumferential edge is sharp enough such that water pressure and other such forces do not axially separate the pipe from the tubular member, yet dull enough so as to provide an adequate seal such that water does not leak out from between the pipe and the tubular member. Additionally, an exterior hose clamp or similar device may be required to be secured around the pipe, such as by crimping or using a screw fastener, radially outwardly adjacent such ridges so as to assure that both the gripping and the sealing functions of the tubular member are adequate. However, such crimping or clamping costs money in the form of the clamp and the associated installation labor. The pipe typically cannot be removed from the pipe connector by pulling therefrom and typically must be longitudinally cut for removal from the pipe connector which can damage the sealing function thereof. Various hose and pipe connectors are described in my co-pending U.S. patent application Ser. No. 09/415,690 (Ericksen et al), which is hereby incorporated by reference.

Irrigation stakes including a garden hose fitting or coupling integrally formed with the stake have been used to retain a coupling in position at a particular location above the surface of the ground. However, such stakes have been limited to use with garden hoses having the normal hose fittings.

### SUMMARY OF THE INVENTION

According to the invention, a connector provides a fitting for connecting lengths of substantially flexible irrigation pipe or hose, such as polyethylene irrigation pipe or garden hose, to the connector which also includes fittings for connecting sprinklers and/or additional lengths of such pipe or hose, and includes a stake as an integral part of the connector so that the stake can be pushed into the ground at a desired location and the connector is held at that location. Such connectors allow selected lengths of pipe or hose to be connected to sprinklers wherein the length is selected to coincide with the length required between the particular sprinklers used so that a user can easily correctly space sprinklers by merely extending the pipe or hose to its length between connectors. Further, lengths of pipe or hose without couplings or hose fittings on the ends thereof can be used by merely inserting the pipe or hose connecting fitting of the connector of the invention into the end of the pipe or hose used. Thus, if a plurality of sprinklers with recommended distance between them of fifteen feet are used and connected to the sprinkler connecting fitting portion of the connector, pipe or hose can be cut to fifteen foot lengths and the connectors of the invention connected to the ends of such lengths. Then a user merely needs to pull the pipe or hose straight between connectors and the user automatically has the correct distance between sprinklers. This job is made easier because the connectors can be staked to the ground using the integral stake as a user progresses in setting the successive sprinklers.

The fitting or fittings for connecting the end of a substantially flexible irrigation pipe or hose to the connector, such pipe or hose also having smooth inside walls, is preferably a spiral ribbed fittings that can be inserted into the end of such pipe or hose to hold the pipe or hose securely on the fitting without leakage. The spiral ribbed fitting portion of the connector includes an exterior tapered, annular end or pilot rib, from which one or more tapered, spiral exterior ribs (more than one being interwound) are disposed on a tapered tubular body. The taper of the pilot rib and the spiral rib(s) allows for easy attachment of a resilient irrigation pipe or tube, but a sharp rear edge of each retains the pipe thereon until forcibly removed, or preferably, the spiral connector and/or the pipe are rotated so as to unscrew the spiral ribbed connector from the pipe. The tapered design of the body increasingly flares the pipe the further it is pushed thereonto, with the spiral rib(s) sealing against the relatively smooth, interior surface of a standard irrigation pipe preventing leakage of liquid between the pipe and the spiral wound connector.

### THE DRAWINGS

The best mode presently contemplated for carrying out the invention is illustrated in the accompanying drawings, in which:

FIG. 1 is a side elevational view of a spiral ribbed connector of the invention as part of a first embodiment irrigation stake of the invention which includes a male threaded hose connector;

FIG. 2, a perspective view of such first embodiment irrigation stake;

FIG. 3, a fragmentary lateral vertical sectional view taken on the line 3-3 of FIG. 2, showing the water channel connecting the spiral ribbed connector to the male threaded connector;

FIG. 4, a lateral horizontal sectional view taken on the line 4-4 of FIG. 1 showing the cross-section of the body of the stake;

FIG. 5, a side elevational view of the spiral ribbed connector as part of a second embodiment irrigation stake of the invention having a pair of oppositely extending spiral ribbed connectors and a male threaded hose connector;

FIG. 6, a perspective view of such second embodiment irrigation stake;

FIG. 7, a fragmentary lateral vertical sectional view taken on the line 7-7 of FIG. 6, showing the water channel connecting the two spiral ribbed connectors to the male threaded connector;

FIG. 8, a side elevational view of the spiral ribbed connector as part of a third embodiment irrigation stake of the invention having respective male and female threaded hose connectors;

FIG. 9, a perspective view of such third embodiment irrigation stake;

FIG. 10, a fragmentary lateral vertical sectional view taken on the line 10-10 of FIG. 9, showing the rotary connection of the female threaded connector to the body of the irrigation stake and the water channel connecting the spiral ribbed connector, the male, and the female threaded connectors;

FIG. 11, a side elevational view of the spiral ribbed connector as part of a fourth embodiment irrigation stake of the invention having a pair of male hose connectors having differing threads;

FIG. 12, a perspective view of such fourth embodiment irrigation stake;

FIG. 13, a fragmentary lateral vertical sectional view taken on the line 13-13 of FIG. 12, showing the water channel connecting the spiral ribbed connector and the male threaded connectors;

FIG. 14, a side elevational view of the spiral ribbed connector as part of a fifth embodiment irrigation stake of the invention having a pair of angularly positioned spiral hose connectors and a male threaded hose connector;

FIG. 15, a perspective view of such fifth embodiment irrigation stake;

FIG. 16, a fragmentary lateral horizontal sectional view taken on the line 16-16 of FIG. 14, showing the water channel connecting the spiral ribbed connectors and the male threaded connector;

FIG. 17, a side elevational view of the spiral ribbed connector as part of a tee fitting of the invention having respective male and female threaded hose connectors;

FIG. 18, a perspective view of such tee fitting; and

FIG. 19, a fragmentary lateral vertical sectional view taken on the line 19-19 of FIG. 18, showing the fixed connection of the female threaded connector to the body of the tee fitting and the water channel connecting the spiral ribbed connector, the male, and the female threaded connectors.

### DETAILED DESCRIPTION OF THE ILLUSTRATED EMBODIMENTS

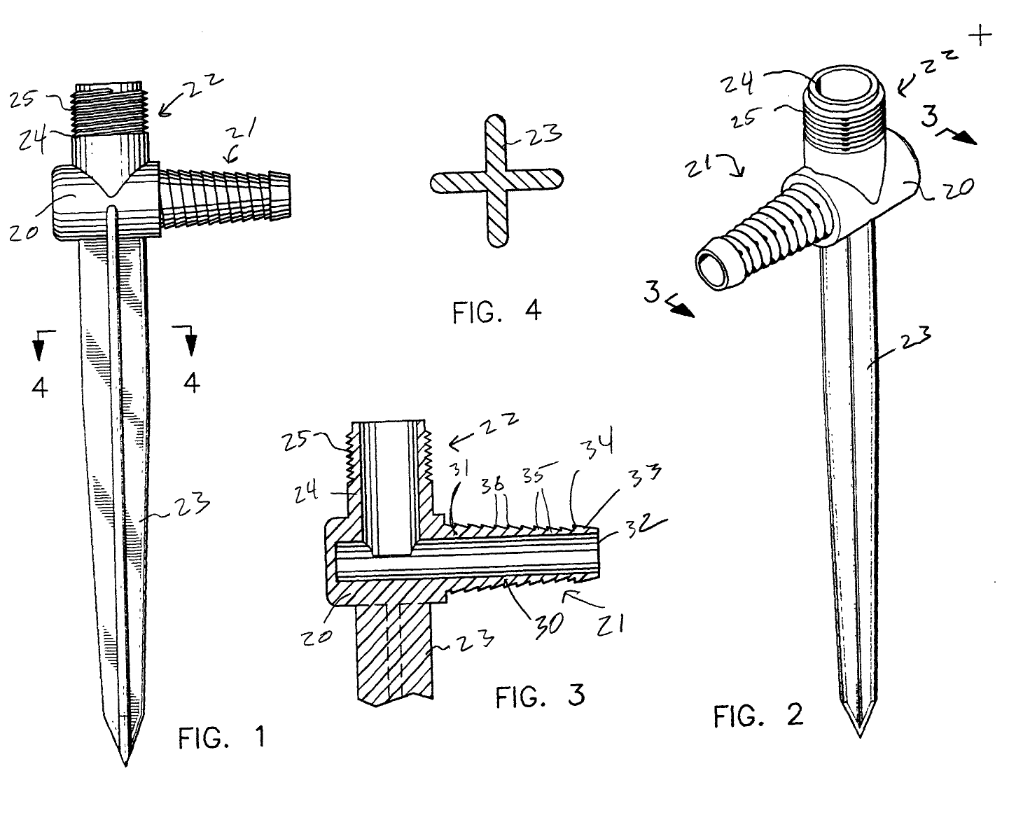

FIGS. 1-4 shows a basic connector of the invention adapted to connect a smooth inside walled, substantially flexible irrigation pipe to a sprinkler head. As shown, a connector body 20 has a fitting 21 for attachment to a smooth inside walled, substantially flexible irrigation pipe extending from one end thereof and a fitting 22 for attachment of a sprinkle thereto extending from the top thereof. A stake 23 extends from the bottom of the connector body. The fitting for attachment of the sprinkler has an externally threaded sprinkler attachment body 24 with normal pipe threads 25 to receive a sprinkler, not shown, such as a normal spray head or pop-up head having a threaded female inlet opening therein so it can be screwed onto threads 25. If a sprinkler having a male inlet opening is to be used, such as most standard impact sprinklers, one end of a threaded sleeve or coupling, not shown, is threaded onto threads 25 and the male sprinkler inlet is threaded into the other end of the sleeve or coupling.

While several configurations of fittings for attachment of the smooth inside walled, substantially flexible irrigation pipe may be used, a preferred fitting is illustrated in FIGS. 1-4, and includes a tubular fitting body 30 extending from connector body 20. Tubular fitting body 30 tapers from a maximum outside diameter adjacent the connector body 20 in the area indicated generally as 31 to a minimum outside diameter at remote end 32 away from the connector body 20. The outside diameter at remote end 32 is less than the inside diameter of an irrigation pipe expected to be attached thereto. A pilot rib 33 tapers radially outwardly from remote end 32 back toward connector body 20 and ends in an annular rib edge 34. A spiral rib 35 extends spirally along tubular fitting body 30, preferably from the edge 34 of pilot rib 33 toward and almost to connector body 20. Spiral rib 35 tapers from fitting body 30 radially outwardly and toward connector body 20 to spiral rib edge 36 which drops steeply back to fitting body 30. Spiral rib edge 36 tapers radially outwardly as it spirals back toward connector body 20, generally carrying the taper of fitting body 30. Spiral rib edge 36 has an outside diameter as it approaches connector body 20 which is at least slightly greater than the inside diameter expected for an irrigation pipe to be connected thereto.

In use, connector 20 and the pipe to be connected are positioned so that remote end 32 of fitting 21 is adjacent the end of the pipe to be connected. Remote end 32 and the end of pilot rib 33 adjacent remote end 32, which have outside diameters less than the inside diameter of the pipe to be connected, are inserted into the end of the pipe. The pipe and connector are pushed together with fitting 21 sliding into the end of the pipe. The taper of the fitting, particularly the taper of rib edge 36, expands the pipe end as it is pushed farther into the pipe. The outside diameter of the rib edge 36 toward connector body 20 being slightly greater than the inside diameter of the pipe expands the end of the irrigation pipe being connected as it is pushed toward connector 20 so that rib edge 36 will seal against the inside of the pipe. Depending upon the pipe and the configuration of the rib edge 36, a hose clamp may be desirable or necessary to securely hold the attached pipe on the fitting and/or to prevent leaks. In many cases, however, the configuration of the rib edge 36 and fitting 21 is such that it will securely hold a connected pipe and seal against leaks without use of a hose clamp. The irrigation pipe to be connected can generally be pushed onto the fitting 21, although in some instances it may be necessary to screw the fitting into the pipe at least for the last portion of its travel into the pipe. Generally the fitting will be more easily screwed out of the pipe than pulled out when removal is desired.

While pilot rib 33 is currently preferred to guide the fitting 21 into the pipe to be connected and to initially start expansion of the pipe end, such pilot rib is not necessary. Spiral rib 35 will start from tapered tube 30 at a location where both tapered tube 30 and spiral rib 35 have outside diameters less than the inside diameter of the pipe to be connected so will fit into and expand the pipe as the fitting is inserted into the pipe end.

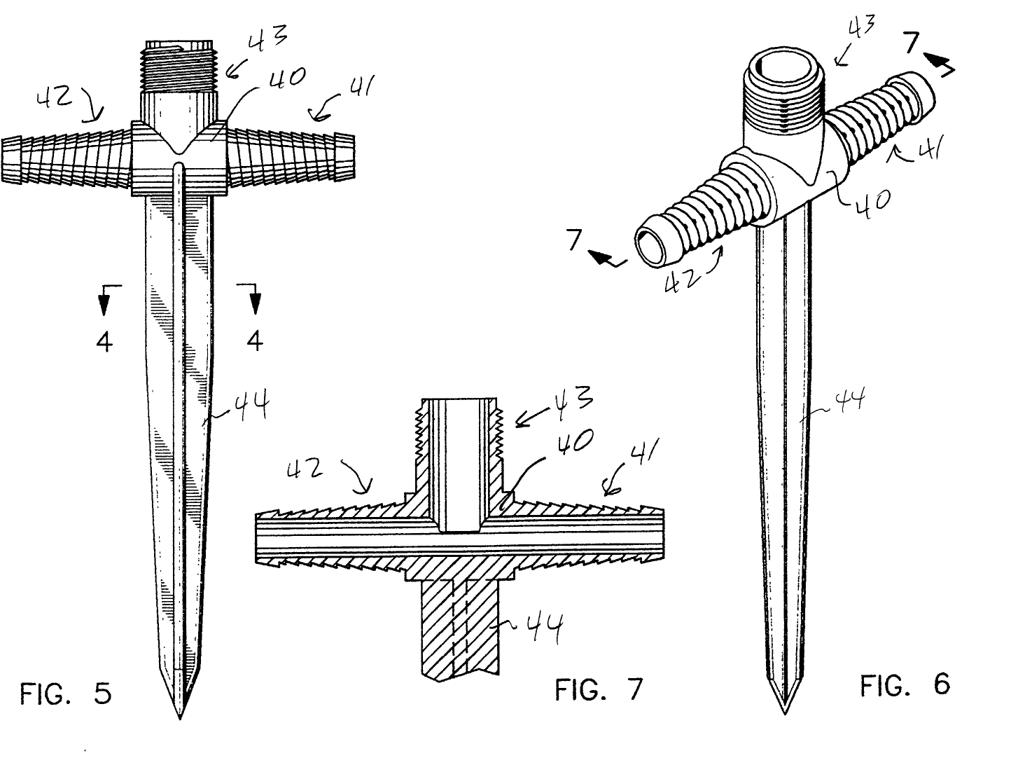

FIGS. 5-7 show an embodiment of the connector of the invention for not only connecting an irrigation pipe to a sprinkler, but for also connecting a second irrigation pipe. The connector includes a connector body 40 with fittings 41 and 42 extending from opposite ends of body 40 for connection to smooth inside walled, substantially flexible irrigation pipes. These fittings are identical to fitting 21 described for FIGS. 1-4. The connector also includes a fitting 43 for connection of a sprinkler and a stake 44 to secure the connector at a location in the ground. With this embodiment, an irrigation pipe is connected to a sprinkler and a second irrigation pipe extends from the connector to a second sprinkler. A plurality of these connectors can be used to create a line of connected sprinklers which can be move and repositioned as desired.

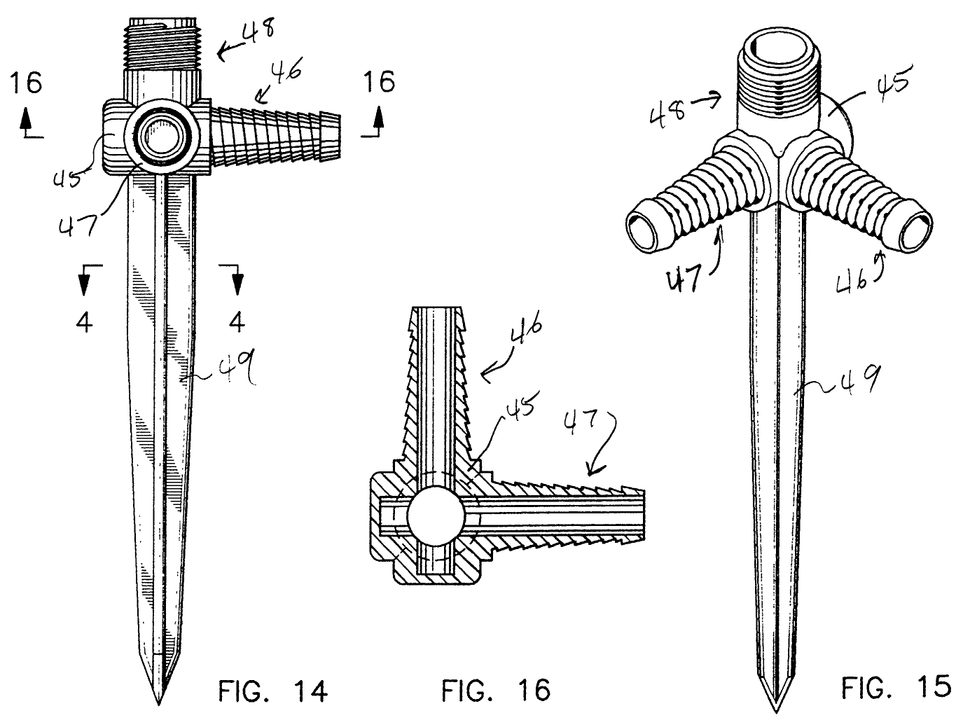

FIGS. 14-16 show an embodiment similar to that of FIGS. 5-7, with a connector body 45, two fittings 46 and 47 for attachment to smooth inside walled, substantially flexible irrigation pipe, a fitting 48 for attachment to a sprinkler, and a stake 49 for insertion into the ground. The fittings are all identical to those described for FIGS. 1-4. The only difference between the connector of FIGS. 14-16 from that of FIGS. 5-7 is that the first fitting 46 and second fitting 47, both for attachment to irrigation pipes, are positioned at ninety degree angles to one another rather than extending from opposite ends of the connector body in a straight line.

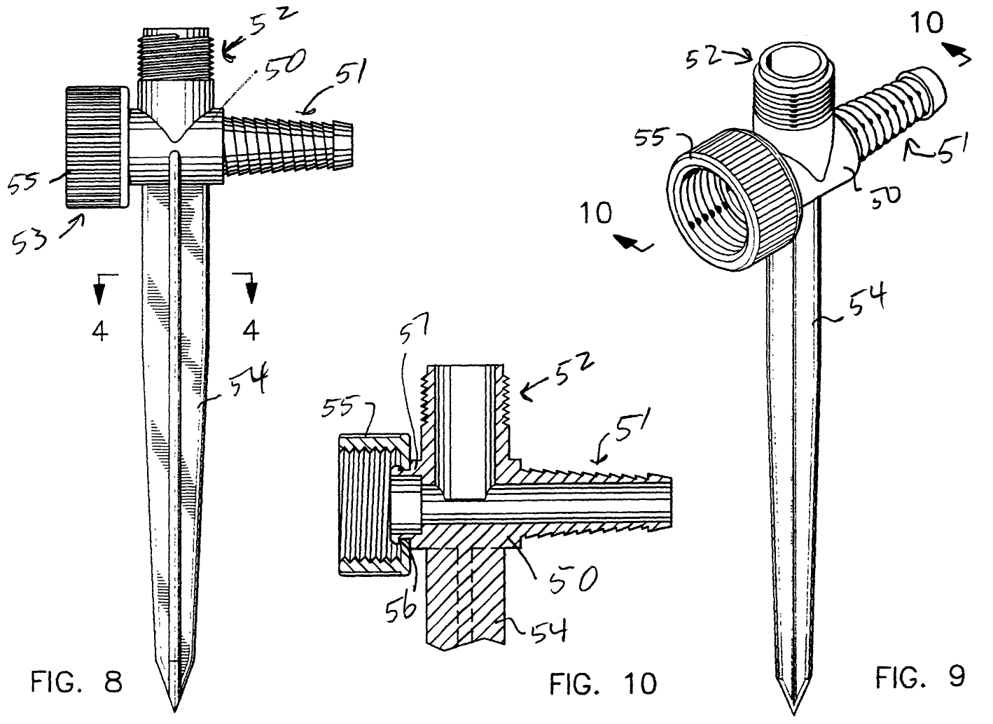

FIGS. 8-10 show an embodiment of the invention with a connector having a connector body 50, a fitting 51 for connection to a smooth inside walled, substantially flexible irrigation pipe, a fitting 52 for connection of a sprinkler, and a female hose fitting 53 for connection to the male end of a normal garden hose. The fitting 51 for connection to the irrigation pipe, the fitting 52 for connection of a sprinkler, and the stake 54 are identical to the similar fittings described for FIGS. 1-4. Fitting 53 for attachment to the male end of a normal garden hose includes an internally threaded sleeve 55 which is snapped into an annular groove 56 on fitting extension 57 so as to be rotatable secured to the connector. The connector of FIGS. 8-10 is used when a regular garden hose is utilized to supply water to the sprinklers in the system using the connectors. In such instance, a connector as shown in FIGS. 8-10 is the first connector in a system made up of a plurality of connectors to provide a plurality of sprinklers. A regular garden hose is connected to a water facut with it female connector. The male connector on the opposite end of the hose is then connected to the connector through fitting 55. A sprinkler is connected to fitting 52. A smooth inside walled, substantially flexible irrigation pipe is connected to fitting 51 and extends to another connector with sprinkler such as a connector of FIGS. 5-7 or 14-16 to extend the system to still further connectors, with an end of system connector as in FIGS. 1-4 to end the system with a sprinkler. The garden hose connection as the initial source of water provides flexibility to move the connected system of connected sprinklers and irrigation pipe any desired distance from a faucet source of water.

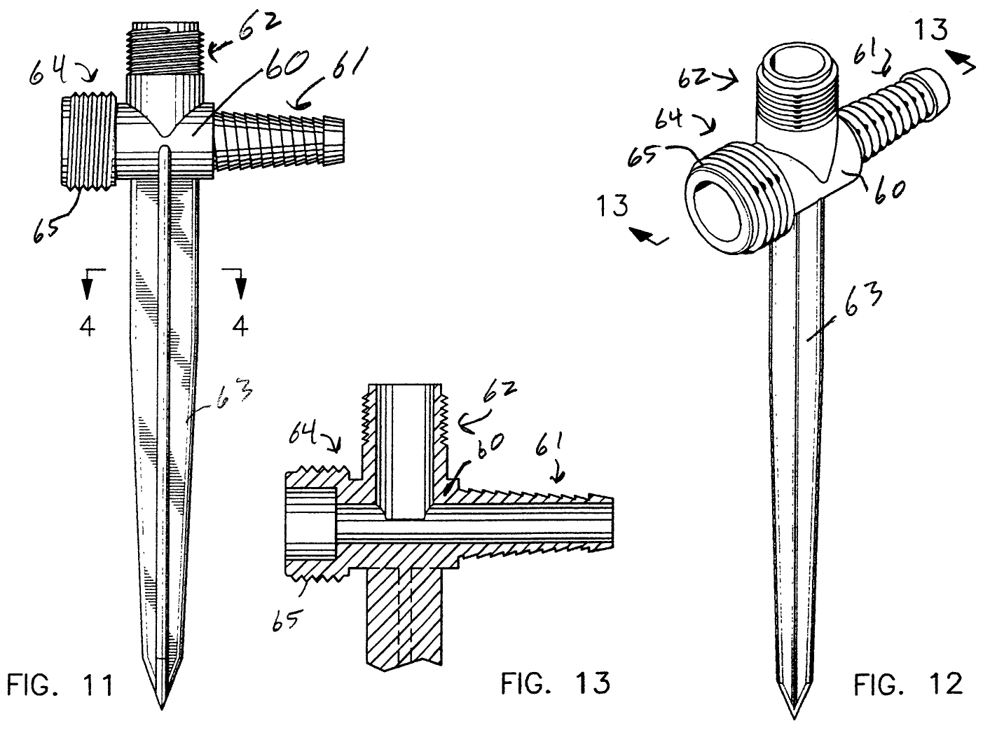

FIGS. 11-13 show a connector similar to that of FIGS. 8-10, but with a male garden hose fitting rather than a female garden hose fitting. Thus, connector body 60 has fittings 61 and 62 extending therefrom for connection of a smooth inside walled, substantially flexible irrigation pipe and sprinkler, respectively. A stake 63 extends from the bottom of connector body 60. Fitting 64 extends from body 60 in a direction opposite from the extension of fitting 61, although any orientation could be used, and is externally threaded with hose threads 65 to mate with a female fitting on a regular garden hose. In this case, if a double female ended hose is used, the hose could be used as a water source as described for the embodiment of FIGS. 8-10. If a normal garden hose is used, water is supplied by an irrigation pipe connected to fitting 61, and the female end of the regular garden hose is connecter to fitting 64 and extends to another sprinkler or other water using device as desired.

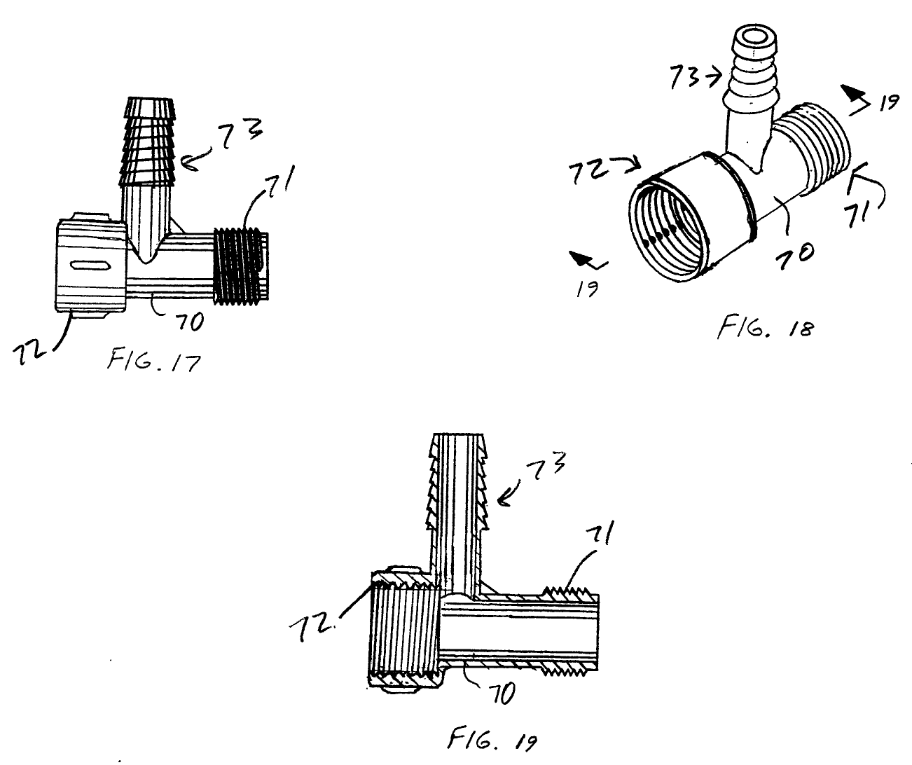

FIGS. 17-19 show an embodiment of connector wherein a spiral ribbed connector of the invention is used with a combination male and female hose connector. Thus, connector body 70 has a male hose fitting 71 formed at one end thereof and a female hose fitting 72 formed at an opposite end thereof. A fitting 73 for connection to a smooth inside walled, substantially flexible irrigation pipe also extends from connector body 70. The fitting 73 is identical to the fitting 21 of FIGS. 1-4. With the fitting of FIGS. 17-19, a smooth inside walled, substantially flexible irrigation pipe can be connected between two regular garden hoses and extend to other connectors with sprinklers or other water use devices.

The term irrigation pipe as used herein may refer to various types of pipe. Smooth inside walled, substantially flexible irrigation pipe refers to any pipe or hose that is flexible enough so that it will expand slightly as it is pushed onto the attachment fitting to provide a seal, either without or with the help of a hose clamp secured around the pipe and fitting. Also, the pipe can bend enough that it can be curved slightly around obstacles as it is moved. Polyethylene irrigation pipe and normal garden hose, as well as vinyl or rubber tubing, fall within this definition.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

1. A connector for connecting a length of irrigation pipe to an item for delivering water supplied to the connector, comprising:
a connector body;
a fitting extending from the connector body for attachment to an end of a smooth inside walled, substantially flexible irrigation pipe;
a fitting extending from the connector body for attachment to an inlet end of an item for delivering water from the connector body; and
a stake extending from the connector body adapted to be pressed into the ground to hold the connector in selected position with respect to the ground.

2. A connector for connecting a length of irrigation pipe to an item for delivering water supplied to the connector according to claim 1, wherein the fitting extending from the connector body for attachment to an inlet of an item for delivering water from the connector body is a fitting for attachment of a sprinkler.

3. A connector for connecting a length of irrigation pipe to an item for delivering water supplied to the connector according to claim 2, wherein the connector additionally includes a second fitting extending from the connector body for attachment to an end of a second smooth inside walled, substantially flexible irrigation pipe.

4. A connector for connecting a length of irrigation pipe to an item for delivering water supplied to the connector according to claim 3, wherein the second fitting for attachment to an end of a second smooth inside walled pipe extends from an opposite end of the connector body than does the fitting for attachment to an end of a smooth inside walled pipe.

5. A connector for connecting a length of irrigation pipe to an item for delivering water supplied to the connector according to claim 4, wherein the fitting and second fitting extend in a straight line.

6. A connector for connecting a length of irrigation pipe to an item for delivering water supplied to the connector according to claim 3, wherein the second fitting for attachment to an end of a second smooth inside walled pipe extends from an the connector body at an angle of ninety degrees from the fitting for attachment to an end of a smooth inside walled pipe.

7. A connector for connecting a length of irrigation pipe to an item for delivering water supplied to the connector according to claim 3, wherein the fitting and the second fitting for attachment to an end of a smooth inside walled pipe comprises:
a tubular fitting body extending from the connector body tapering from a maximum outside diameter adjacent the connector body to a minimum diameter at a remote end away from the connector body, the minimum diameter being less than the normal inside diameter of the pipe to be connected;
a spiral rib extending spirally around the fitting body from a starting position away from the coupling body and extending toward the coupling body, the spiral rib having an edge along its length radially outwardly of the fitting body from which it extends, said edge tapering radially outwardly as it approaches the coupling body and having an outer diameter greater than the inside diameter of the pipe as it approaches the coupling body.

8. A connector for connecting a length of irrigation pipe to an item for delivering water supplied to the connector according to claim 7, additionally including a pilot rib positioned between the remote end and the start of the spiral rib, said pilot rib tapering from the remote end radially outwardly as it extends toward the connector body.

9. A connector for connecting a length of irrigation pipe to an item for delivering water supplied to the connector according to claim 2, additionally including a fitting extending from the body for connecting a garden hose thereto.

10. A connector for connecting a length of irrigation pipe to an item for delivering water supplied to the connector according to claim 9, wherein the additional fitting includes female hose threads for connecting the male end of the hose.

11. A connector for connecting a length of irrigation pipe to an item for delivering water supplied to the connector according to claim 9, wherein the additional fitting includes male hose threads for connecting the female end of the hose.

12. A connector with a fitting for connecting to a length of smooth inside walled, substantially flexible irrigation pipe having a normal inside diameter, comprising:
a connector body;
a tubular fitting body extending from the connector body tapering from a maximum outside diameter adjacent the connector body to a minimum diameter at a remote end away from the connector body, the minimum diameter being less than the normal inside diameter of the pipe to be connected; and
a spiral rib extending spirally around the fitting body from a starting position away from the coupling body and extending toward the coupling body, the spiral rib having an edge along its length radially outwardly of the fitting body from which it extends, said edge tapering radially outwardly as it approaches the coupling body and having an outer diameter greater than the inside diameter of the pipe as it approaches the coupling body.

13. A connector with a fitting for connecting to a length of smooth inside walled, substantially flexible irrigation pipe having a normal inside diameter according to claim 12, additionally including a pilot rib positioned between the remote end and the start of the spiral rib, said pilot rib tapering from the remote end radially outwardly as it extends toward the connector body.

14. A connector with a fitting for connecting to a length of smooth inside walled, substantially flexible irrigation pipe having a normal inside diameter according to claim 13, additionally including a fitting for attachment to a garden hose extending from the body.

15. A connector with a fitting for connecting to a length of smooth inside walled, substantially flexible irrigation pipe having a normal inside diameter according to claim 14, additionally including a second fitting for attachment to a second garden hose extending from the body.

16. A connector with a fitting for connecting to a length of smooth inside walled, substantially flexible irrigation pipe having a normal inside diameter according to claim 15, wherein the fitting for attachment to a garden hose has female hose threads for attachment to a male fitting of the garden hose, and the second fitting for attachment to a garden hose has male hose threads for attachment to a female fitting of the second garden hose.

17. A connector with a fitting for connecting to a length of smooth inside walled, substantially flexible irrigation pipe having a normal inside diameter according to claim 13, additionally including a fitting for attaching a sprinkler extending from the body.

18. A connector with a fitting for connecting to a length of smooth inside walled, substantially flexible irrigation pipe having a normal inside diameter according to claim 12, additionally including a fitting for attachment of a sprinkler extending from the body.

19. A connector with a fitting for connecting to a length of smooth inside walled, substantially flexible irrigation pipe having a normal inside diameter according to claim 12, additionally including a stake extending from the body adapted to be pressed into the ground to hold the connector in selected position with respect to the ground.
